(19) United States
(12) Patent Application Publication
(10) Pub. No.: US 2026/0143373 A1
(43) Pub. Date: May 21, 2026

(54) CELL HEALTH METRICS MANAGEMENT

(71) Applicant: Rakuten Symphony, Inc., Tokyo (JP)

(72) Inventors: Pratim Pal, Bangalore (IN); Pranshu Sood, Bangalore (IN); Vinay Kumar Nagendra, Bangalore (IN); Rakesh Chiduva Ramakrishna, Bangalore (IN)

(73) Assignee: Rakuten Symphony, Inc., Tokyo (JP)

(21) Appl. No.: 18/954,965

(22) Filed: Nov. 21, 2024

(51) Int. Cl. H04W 24/10; G06F 9/448

(52) U.S. Cl. CPC H04W 24/10; G06F 9/4498

(57) ABSTRACT

Example embodiments of the present disclosure relate to cell health metrics management. According to an example embodiment, a device may be configured to receive cell information associated with a cell in a telecommunication network and determine cell health metrics of the cell based thereon. The cell information may include a current state of a finite state machine (FSM) of the cell. The device may also be configured to record the cell health metrics in a local cache and then synchronize a table with the cell health metrics recorded in the local cache based on determining that the predetermined time period has elapsed. Further, the device may also be configured to transmit the table to a northbound component of the telecommunication network.

### TECHNICAL FIELD

The present disclosure relates to the management of cell health metrics.

### BACKGROUND

The information disclosed in this background section is only for the enhancement of understanding of the general background of the disclosure and should not be taken as an acknowledgement or any form of suggestion that this information forms the prior art already known to a person skilled in the art.

In a telecommunication network, a cell may refer to an area that defines the cellular coverage zone covered by a base station. Each cell may contain network components, such as a radio transmitter and receiver, that provide network coverage and facilitate communication between user equipment (UE) and the network. Cell health metrics or statistics are important parameters in the telecommunication network, since they are closely related to the network performance, availability, and reliability.

### SUMMARY

Example embodiments of the present disclosure provide a system, a device, a method, and the like, that leverages various novel mechanisms associated with cell health metrics management.

According to example embodiments, a device may be configured to: receive cell information associated with a cell in a telecommunication network, determine cell health metrics associated with the cell based on the cell information, record the cell health metrics in a local cache, determine whether a predetermined time period has elapsed, synchronize a table with the cell health metrics recorded in the local cache based on determining that the predetermined time period has elapsed, and transmit the table to a northbound component of the telecommunication network. The cell information may include a current state of a finite state machine (FSM) associated with the cell, and the current state may include at least one of: an Idle state, an Inactive state, and an Active state.

According to example embodiments, a method may include: receiving cell information associated with a cell in a telecommunication network, determining cell health metrics associated with the cell based on the cell information, recording the cell health metrics in a local cache, determining whether a predetermined time period has elapsed, synchronizing a table with the cell health metrics recorded in the local cache based on determining that the predetermined time period has elapsed, and transmitting the table to a northbound component of the telecommunication network. The cell information may include a current state of an FSM associated with the cell, and the current state may include at least one of: an Idle state, an Inactive state, and an Active state.

According to example embodiments, a non-transitory computer-readable recording medium may have recorded thereon instructions executable by a device to cause the device to perform a method. The method may include: receiving cell information associated with a cell in a telecommunication network, determining cell health metrics associated with the cell based on the cell information, recording the cell health metrics in a local cache, determining whether a predetermined time period has elapsed, synchronizing a table with the cell health metrics recorded in the local cache based on determining that the predetermined time period has elapsed, and transmitting the table to a northbound component of the telecommunication network. The cell information may include a current state of an FSM associated with the cell, and the current state may include at least one of: an Idle state, an Inactive state, and an Active state.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a block diagram of an example open radio access network (O-RAN) architecture, according to one or more example embodiments;

FIG. 2 illustrates a diagram of an example system configuration in the related art;

FIG. 3 illustrates a diagram of a non-limiting use case in the related art;

FIG. 4 illustrates a diagram of an example system configuration for managing cell health metrics, according to one or more example embodiments;

FIG. 5 illustrates a diagram of example FSM states of a cell, according to one or

more example embodiments;

FIG. 6 illustrates a diagram of a first non-limiting use case, according to one or more example embodiments;

FIG. 7 illustrates a diagram of a second non-limiting use case, according to one or more example embodiments;

FIG. 8 illustrates a diagram of a third non-limiting use case, according to one or more example embodiments;

FIG. 9 illustrates a flow diagram of an example method for managing cell health metrics, according to one or more example embodiments; and

FIG. 10 illustrates an embodiment of a device which may implement one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the Open Radio Access Network (O-RAN) Alliance, the 3rd Generation Partnership Project (3GPP) standard organization, the European Telecommunications Standards Institute (ETSI) standard organization, and the like. For instance, the terms “SMO”, “CU”, “DU”, “RU”, and the like, as well as the associated features and operations, are to be interpreted as consistent with those specified in one or more technical specifications, unless being described otherwise.

A radio access network (RAN) is an important component in a telecommunications system, as it connects end-user devices (or user equipment) to other parts of the network. The RAN includes a combination of various network elements (NEs) that connect end-users to a core network. Traditionally, the hardware and/or software of a particular RAN is vendor-specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized and/or containerized in software form (e.g., virtual machine (VM)-based, containerized network function (CNF)-based, etc.), or could be in physical hardware form (e.g., non-VM-based, non-CNF-based, etc.). Accordingly, O-RAN disaggregates the RAN functions into different entities, such as a central unit (CU), a distributed unit (DU), and a radio unit (RU). Since these entities have open protocols and interfaces between them, they can be developed by different vendors.

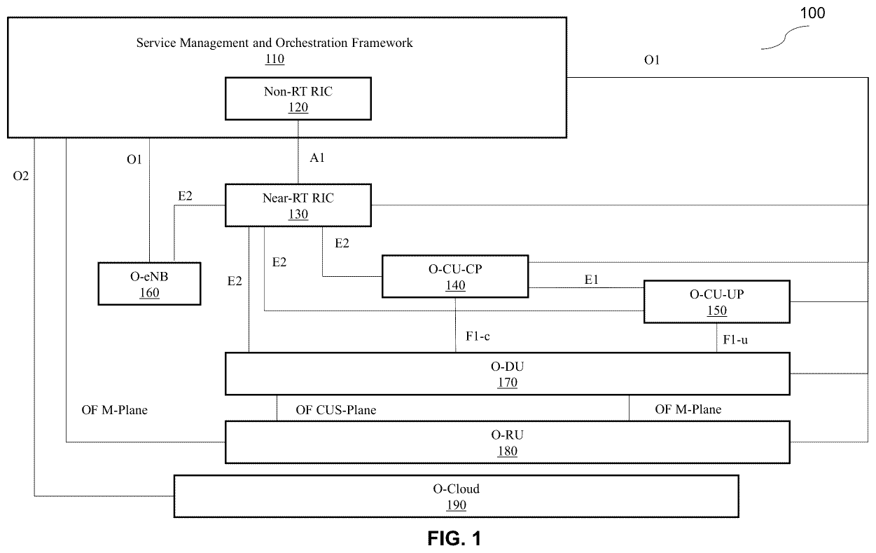

One or more example embodiments of the present disclosure may be implemented in an O-RAN architecture. FIG. 1 illustrates a block diagram of an example O-RAN architecture 100, according to one or more example embodiments. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy-based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140/150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, O-eNB 160, etc.) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronthaul (OF) Control (C), User (U), Synchronization(S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-Ran Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

The O-CU 140, 150, the O-DU 170, and the O-RU 180 may constitute a base station, such as a gNodeB (gNB) of 5G NR, a node in Next Generation Radio Access Network (NG-RAN), a base station of a 6G network, and the like. On the other hand, the O-eNB 160 may refer to a 4G LTE version of the O-RAN-compliant node (e.g., an eNB that adheres to the O-RAN architecture).

In some example implementations, the system may include a plurality of O-DUs 170, and the O-CU 140, 150 may be communicatively coupled to the plurality of O-DUs 170. Similarly, the system may include a plurality of O-RUs 180, and the O-DU(s) 170 may be communicatively coupled to the plurality of O-RUs 180 via one or more of the O-FH C/U/S/M plane interfaces.

According to example embodiments, the O-CU 140, 150 and the O-DU 170 may be defined in software form and may be deployed in one or more network nodes. For instance, the O-CU 140, 150 and the O-DU 170 may be deployed in one or more servers in the form of virtualized network function (VNF), containerized and/or cloud-native function (CNF), and the like. According to example embodiments, the O-CU 140, 150 and the O-DU 170 may be deployed in the same network node (e.g., same server) and/or may be located at a similar geographical location (e.g., be deployed in different servers in the same data center). According to example embodiments, the O-CU 140, 150 and the O-DU 170 may be deployed in different network nodes and/or may be located at different geographical locations. For instance, the O-CU 140, 150 may be deployed in one or more central servers (i.e., servers in one or more central data centers), and the O-DU 170 may be deployed in one or more edge servers (i.e., servers in one or more edge data centers).

The O-DU 170 may receive radio signals from an end user (via one or more UEs and one or more cells) and may provide operation or support for lower layers of protocol stacks (e.g., RLC layer, MAC layer, Physical Layer, etc.) accordingly. As an example, the O-DU 170 may perform one or more scheduling operations. The O-CU 140, 150 may communicatively couple the O-DU 170 to a core network (e.g., 4G Evolved Packet Core (EPC) network, 5G Core network, etc.) and may receive the radio signals from the O-DU 170, thereby providing operation or support for higher layers of protocol stacks (e.g., PDCP layer, RRC layer, etc.) accordingly.

Further, a single O-DU 170 may host or serve multiple network cells formed by multiple O-RUs 180. According to example embodiments, the O-DU 170 may implement various radio technologies, such as massive multiple-input multiple-output (MIMO), beamforming, and the like, to optimize radio communication among the multiple cells and the O-CU 140, 150. In some example implementations, the O-DU 170 may concurrently host or serve hundreds (e.g., 256, 512, etc.) of cells at a time.

The O-RU(s) 180 may be a physical node that converts radio signals from antennas to digital signals that can be transmitted over the Front Haul to the O-DU 170. In this regard, a network cell described herein may correspond to one or more radio units responsible for providing wireless coverage and signal transmission within the network cell. The network cell may include a macro cell, a micro cell, a pico cell, a femto cell, and/or any other suitable type of network cell. Each of the cells may have an associated coverage area, in which at least one O-RU 180, at least one antenna system, and any other suitable type of transport network element (TNE), may be deployed therein.

It is contemplated that example embodiments of the present disclosure may also be implemented in any other suitable telecommunication network architecture, in addition to or in alternative to the O-RAN architecture.

As mentioned above, cell health metrics are important parameters in a telecommunication network since they are associated with the performance, availability, and reliability of the network. Cell health metrics may include statistical key performance indicators (KPIs) associated with a cell, such as an operational uptime and an operational downtime of a cell. The uptime of a cell refers to the amount of time the cell is operational and available to, for example, handle network traffic. Conversely, the downtime of a cell refers to the amount of time the cell is unavailable or non-functional (or the amount of time the cell is partially functional or in a low-power state).

In the related art, the cell health metrics may be collected or computed by the DU (e.g., O-DU, etc.) and then be further transmitted to the Northbound components (e.g., CU, SMO, etc.) that are responsible for monitoring the cell health metrics. Nevertheless, as further described below, there is room for improvement in the related art system and method in managing the cell health metrics.

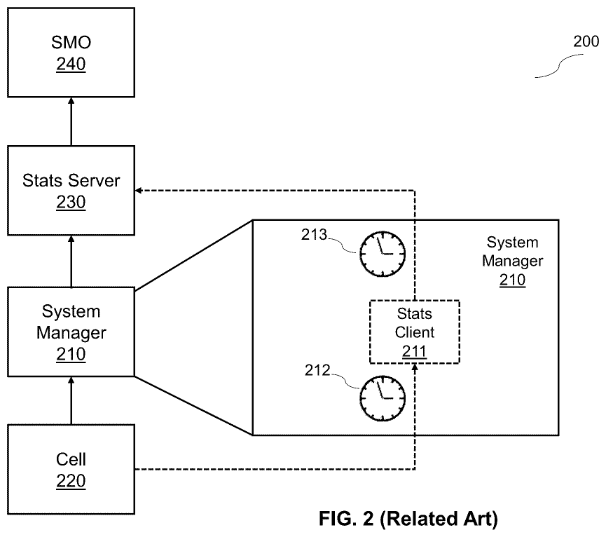

FIG. 2 illustrates a diagram of a system configuration 200 for managing cell health metrics in the related art.

As illustrated in FIG. 2, the system configuration 200 may include a system manager 210, a cell 220, a statistics (stats) server 230, and an SMO 240. Generally, the system manager 210 may collect or compute the cell health metrics of the cell 220 and then transmit them to the stats server 230. Accordingly, the stats server 230 may stream the cell health metrics to the SMO 240, such that the SMO 240 may utilize the cell health metrics in managing the performance, providing predictive maintenance, and ensuring quality of service (QoS).

The system manager 210 may be implemented in a DU (e.g., O-DU, etc.) and may be implemented in software form, such as a software application, a VNF, a CNF, and the like. The system manager 210 may be tasked with computing and/or maintaining cell health metrics or statistics, and may associate two timers 212-213 with the cell 220. These timers operate with a 1-second granularity or interval, one of the timers (e.g., timer 212) may trigger the capturing of cell health metrics (and/or any other suitable statistical KPI of the cell 220) every 1 second and record the associated data or information in a table, another one of the timers (e.g., timer 213) may trigger the transmission of the cell health metrics (e.g., aggregated in the form of the table, etc.) to the stats server 230 every 1 second. The table may be managed by a statistics (stats) client 211 within the system manager 210, and may be hardly coupled with the system manager 210.

Similar to the system manager 210, the stats server 230 may also be implemented in software form. For instance, the stats server 230 may be implemented in a CU (e.g., O-CU), a performance management module, or any other suitable system/platform communicatively coupled to the system manager 210 (or the device that implements the system manager 210). At each second, the stats server 230 may receive the cell health metrics from the system manager 210 (or the stats client 211 implemented therein), and then stream the cell health metrics (or the associated data) to the SMO 240 (or any other suitable northbound components) every 15 minutes (or any other suitable or predetermined time interval).

To this end, in the related art system architecture, each cell is linked to at least two 1-second interval timers. These timers are associated with or responsible for managing the cell health metrics (e.g., operational uptime and downtime metrics, etc.) of their respective cells. Namely, in the related art, at least one timer is required to trigger the collection or aggregation of cell health metrics (e.g., the system manager pushes data to the stats client, etc.) and at least one timer is required to trigger the data streaming to the northbound components (e.g., the stats server).

Given that each cell is required to have at least two 1-second interval timers associated therewith, scaling up the cells in the related art will result in a proliferation of timers. Consequently, the related art system faces significant cell scalability challenges due to resource limitations. As a non-limiting example, a single DU may have the capability to handle or serve 256 cells, but it may be challenging to scale up the number of cells to 256 cells since doing so requires at least 512 timers (each of which operates in a 1-second time interval) to be linked to each of the 256 cells, which may result in network resource contentions and restrictions.

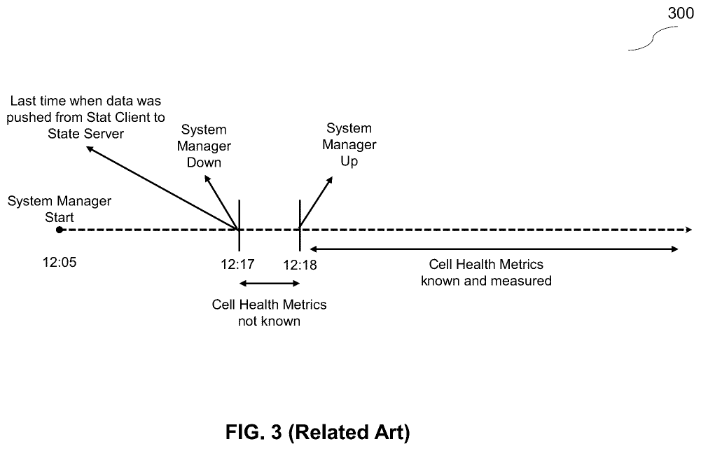

Further, whenever the system manager experiences downtime, the local data of the cell health metrics will be lost, resulting in incomplete and inaccurate cell health statistics metrics. FIG. 3 illustrates a diagram 300 of a non-limiting use case in which the system manager in the related art experiences downtime.

As illustrated in the example of FIG. 3, the system manager started up at 12:05, went down at 12:17, and started up again at 12:18. In this regard, 12:17 was the last time when the data of the cell health metrics was relayed from the system manager (or the stats client implemented therein) to the stats server. Namely, the data from the start until 12:17 was all noted and transmitted to the stats server and further to northbound components.

On the other hand, even when the system manager went down between 12:17 and 12:18, the status of the cell would not be affected (e.g., the state of the cell may remain the same as what it was prior to the system manager going down contingent to the case that nothing happened to the cell when the system manager goes down). In this regard, the data for which the system manager was down (e.g., between 12:17 and 12:18 in the use case of FIG. 3) is lost and not accounted for while the system manager calculates or determines the cell health metrics.

In view of the above, the failure of the system manager may impact the computation and aggregation of cell health metrics and may ultimately impact the network performance and service availability, since the northbound components (e.g., CU, SMO, etc.) that is responsible for monitoring and utilizing the cell health metrics to control the network or services may not obtain accurate or comprehensive cell health metrics from the system manager. Further, in the related art, the recovery or healing of the cell health metrics is required to be performed manually by the user (e.g., network operator, etc.) by, for example, manually accessing the log of the cell and identifying the status of the cell during the downtime of the system manager, etc.

Example embodiments of the present disclosure, as described in the following, provide devices, systems, methods, and the like, that effectively and efficiently manage the cell health metrics, and ultimately address the shortcomings of the related art systems and methods.

Specifically, example embodiments of the present disclosure utilize a local cache (and a database, when applicable) to record transitions of the states of a finite state machine (FSM) of the cells and the associated information, and then calculate or derive the cell health metric based thereon. This allows the example embodiments to reduce the number of timers to only one timer, and further reduce the granularity of the timer (e.g., from 1 second to 1 minute, etc.), thereby reducing the network resources (e.g., CPU usage, etc.) required for managing the cell health metrics. In addition, example embodiments of the present disclosure also provide quick and automated recovery of cell health metrics in the event of the downtime of the system or device that computes and collects the cell health metrics (e.g., the system manager). Specifically, example embodiments of the present disclosure may appropriately determine a delta time (based on the time at which the system/device recovered and the time at which the previously determined cell health metrics were written to the database, etc.) and then compute the cell health metrics based thereon, thereby automatically recovering the cell health metrics without the need of human intervention.

Accordingly, the example embodiments effectively and efficiently provide accurate and comprehensive cell health metrics to the northbound components (e.g., CU, SMO), thereby enabling high availability of network services and high stability of network performance since the northbound components may accurately manage the network/services and perform decision-making based on the accurate and comprehensive data.

It is contemplated that features, advantages, and significances of example embodiments described hereinabove are merely a portion of the present disclosure and are not intended to be exhaustive or to limit the scope of the present disclosure. Further descriptions of the features, components, configuration, and operations of example embodiments are provided in the following.

### Example System Configuration

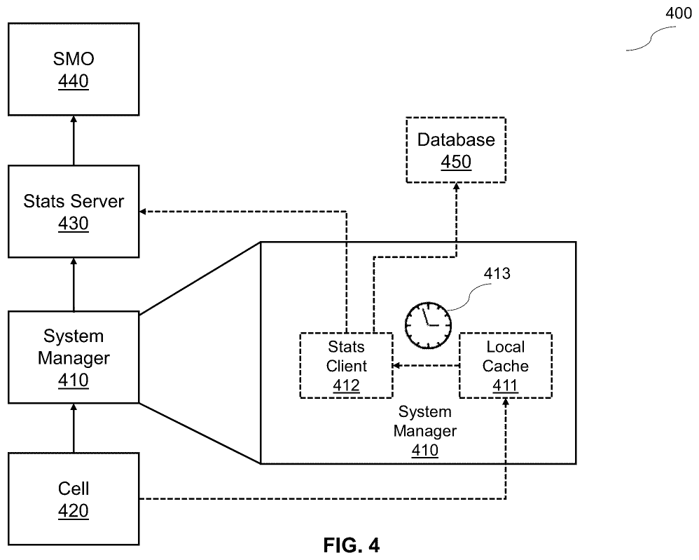

FIG. 4 illustrates a diagram of an example system configuration 400 for managing cell health metrics, according to one or more example embodiments. As illustrated in FIG. 4, the system configuration may include a system manager 410, a cell 420, a stats server 430, and an SMO 440, which may be similar to the system manager 210, cell 220, stats server 230, and SMO 240, respectively, unless described otherwise. For instance, the system manager 410 may also be implemented in a DU (e.g., O-DU) in a software form, the stats server 430 may also be implemented in a northbound component (e.g., a CU, a performance manager module, etc.) in a software form, and the like. The system in FIG. 4 may be implemented in any suitable type of telecommunication network (e.g., O-RAN network, etc.).

The communication between the system manager 410 and the stats server 430 may be performed via a remote procedure call (RPC), such as gRPC, JSON-RPC, XML-RPC, and the like. On the other hand, the communication between the stats server 430 and the SMO 440 (or any other northbound components) may be performed via suitable streaming or transmitting mechanisms, such as Kafka, MinIO, File Transfer Protocol Secure (FTPS)-based technologies, and the like.

As illustrated in FIG. 4, the system manager 410 may include a local cache 411, a stats client 412, and a timer 413. Unlike the related art system manager that requires at least two 1-second interval timers and pushes the cell health metrics to the stats server every 1 second, the system manager 410 may adopt a stateful architecture by managing the state(s) of Finite State Machine (FSM) of the cell 420 (may be referred to as “cell FSM” herein) and provide the cell health metrics to the stats server 430 with a reduced granularity.

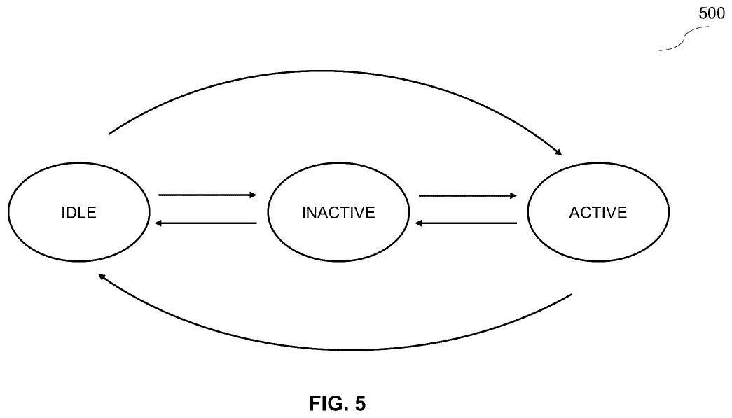

Specifically, for each state transition of the cell FMS (example transitions of the state of the cell FSM are described below with reference to FIG. 5), the system manager 410 may trigger the timer 413 and record the current state of the cell, an associated timestamp, and an associated counter value (may be collectively referred to as “FSM state information” herein) in the local cache 411. Accordingly, after a predetermined time period of the timer 413 has elapsed, the system manager 410 may synchronize a table managed by the stats client 412 with the data recorded in the local cache. The table may be stored locally within the system manager 410 and/or in another storage medium (e.g., database 450). According to some example embodiments, the predetermined time period is at least 1 minute. Further, the stats client 412 may calculate or compute one or more additional information or cell health metrics (e.g., an operational uptime of the cell, an operational downtime of the cell, etc.) based on the FSM state information recorded in the local cache 411 and then update the table to include the computed information/metrics.

The local cache 411 may be configured to temporarily store the FSM state information upon detection of the state transition of the cell FSM. In some example implementations, upon detection of the state transition of the cell FMS, the system manager may compute the cell health metrics based on the FSM state information and populate the local cache 411 with the computed cell health metrics. According to example embodiments, the local cache 411 may accumulate the data until the predetermined time period of the timer 413 has elapsed and the accumulated data has been synchronized with the table. Additionally or alternatively, the local cache 411 may hold the data until the detection of the next state transition of the cell FSM. According to example embodiments where multiple state transitions occur within the predetermined time period (e.g., multiple state transitions occur in 1 minute, etc.), the local cache 411 may store the information of each of the multiple state transitions, or may store the information of one or more specific state transitions (e.g., the latest state transition, the state transitions occurred in the past 30 seconds, etc.). By implementing the local cache 411, the cell health metrics may be accumulated and periodically (e.g., every 1 minute, etc.) synchronized with the table managed by the stats client 412, thereby reducing the granularity of transmission of the cell health metrics to the northbound components (e.g., stats server 430, SMO 440, etc.). Accordingly, the frequency of data transmission between the system manager 410 and the northbound components may be reduced and the associated overhead may be minimized, thereby optimizing the network resources and ensuring that the network is not overwhelmed by high-frequency cell health metrics updates.

In an optional embodiment, the system manager 410 may communicate with a database 450. The database 450 may be located together with or separated from the system manager 410 (or a device, a server, etc. that implements the system manager 410). In this regard, upon detecting the state transition of the cell FSM, the system manager 410 may compute and write the cell health metrics (and/or the FSM state information) to the database 450. Further, in some example embodiments, the system manager 410 may also provide the table to the database 450. In this case, the system manager 410 may be configured to synchronize the table by: obtaining the table from the database 450, updating the table to include the cell health statistics metrics (and/or the FSM state information), and transmitting the updated table to the database 450.

According to example embodiments, after a predetermined time period of the timer 413 has elapsed, the system manager 410 (or the stats client 412) may transmit the table to the stats server 430, prior to/after synchronizing the table with the local cache 411. For example, every 1 minute, the system manager 410 (or the stats client 412) may transmit the table (or data included therein) to the stats server 430, and concurrently, every 1 minute the cell health metrics (and/or the FSM state information) in the local cache 411 may be synchronized or written to the table in the stats client 412.

It is contemplated that, although it is described herein that the cell health metrics are presented and provided to the northbound components in the table form, the scope of the present disclosure should not be limited thereto. Specifically, in some example implementations, in addition to or in alternative to the table, the stats client 412 may manage the cell health metrics in the form of a list, a structured programming language format (e.g., JavaScript Object Notation (JSON), Extensible Markup Language (XML), etc.), a key-value pair, a log file, and the like.

FIG. 5 illustrates a diagram 500 of example FSM states of a cell, according to one or more example embodiments. As illustrated in FIG. 5, the FSM states may include an Idle state, an Inactive state, and an Active state.

The Idle state may refer to a low-power or partially-operational/non-operational state, where the cell is waiting for an event or input to transition into the Active state. In this state, minimal or no operations are performed by the cell. In this regard, as soon as the system manager pushes the cell configuration, the cell will begin with the Idle state and transition to the Active/Inactive state after a series of events (e.g., interactions with peer modules, ending of an inactivity period, etc.). Similarly, the cell may transition to the Idle state from the Active/Inactive state (e.g., when there is no ongoing network traffic, etc.).

The Inactive state may refer to a state of inactivity or a state where the cell is down. In this state, the cell may not serve network traffic and may be temporarily/permanently out of service. This state may be caused by, for example, maintenance, a software failure, a midhaul failure, a fronthaul failure, a timing issue, and/or other reasons. The cell may transition to the Inactive state from the Idle/Active state (e.g., when a software failure occurs, when a cell maintenance is scheduled, etc.). Similarly, the cell may transition from the Inactive state to the Active/Idle state (e.g., completion of the maintenance, etc.).

The Active state may refer to a state where the cell is fully operational and actively serving network traffic. In this state, the cell may perform its primary functions, such as routing data, managing calls, or other communication services for devices within its coverage area. The cell may transition to the Active state from the Idle/Inactive state (e.g., when the cell receives incoming traffic, when the maintenance of the cell is completed, etc.). Similarly, the cell may transition from the Active state to the Idle/Inactive state (e.g., when network traffic drops to zero, when a software failure occurs, etc.).

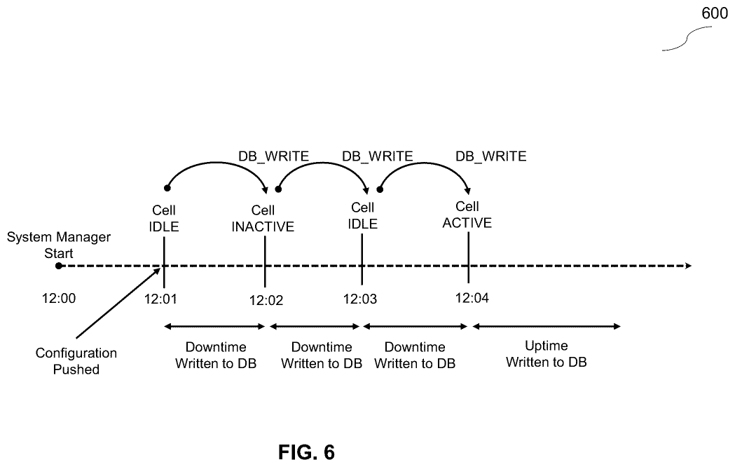

The operational uptime and downtime of the cell may be determined based on the state of the cell FSM and the associated information. For instance, the operational uptime of the cell may be obtained or determined by comparing a timestamp where the Active state begins with a timestamp where the Active state ends, etc. Further descriptions associated with example operations for determining the operational uptime and downtime of the cell are provided below with reference to FIGS. 6-9.

According to example embodiments, the FSM state information may include a downtime counter and/or an uptime counter. The downtime counter may include an integer value that indicates how many times the cell has transitioned into the Idle/Inactive state, and will increase whenever the cell transitions into any state other than the Active state. As a non-limiting example, whenever an operational downtime is determined (e.g., based on determining that the cell has transitioned into the Idle/Inactive state), the system manager may increase the downtime counter by a predefined step (e.g., +1, +2, etc.). Conversely, the uptime counter may include an integer value that indicates how many times the cell has transitioned into the Active state, and will increase whenever the cell transitions into the Active state. As a non-limiting example, whenever an operational uptime is determined (e.g., based on determining that the cell has transitioned into the Active state), the system manager may increase the uptime counter by a predefined step (e.g., +1, +2, etc.). According to example embodiments, the downtime counter and/or the uptime counter may have a maximum counter value, and the system manager (and/or the northbound components) may be configured to perform an operation based on determining that the maximum counter value is satisfied. As a non-limiting example, based on determining that the downtime counter value has increased to 900 (i.e., the associated cell has transitioned into the Idle/Inactive state for 900 times), the system manager (and/or the northbound components) may generate and transmit an alarm to the user (e.g., the network operator, etc.) to notify the user about the cell health status.

According to example embodiments, the downtime counter may be further divided into multiple sub-categories. For instance, the downtime counter may include: a downtime counter associated with a management operation (may be referred to as “downtime_mgmt counter” herein), such as an administrative lock of the cell during a maintenance window, a dynamic configuration change, and the like; a downtime counter associated with a software failure (may be referred to as “downtime_sw counter” herein), such as an unexpected software failure that makes the cell entering the Idle/Inactive state, and the like; a downtime counter associated with other factors (may be referred to as “downtime_other counter” herein), such as a downtime due to a midhaul/fronthaul failure, timing issues, and the like.

FIG. 6 illustrates a diagram 600 of a first non-limiting use case, according to one or more example embodiments.

As illustrated in FIG. 6, the system manager started at 12:00, and the configuration of the cell is pushed to the system manager at 12:01 (i.e., in this example use case, the predetermined time period of the timer is 1 minute). In this regard, the state of the cell at 12:01 begins with Idle state, and the FSM state information (e.g., current state, timestamp, etc.) at 12:01 is recorded in the local cache.

At 12:02, the predetermined time period at the timer has elapsed, and thus the table in the stats client is transmitted to the states server and synchronized with the local cache. At the same time, at 12:02, a state transition (from Idle state to Inactive state) occurs. Accordingly, the system manager will again record the FSM state information in the local cache and transmit the information to the database. The system manager may also calculate or compute the cell health metrics (e.g., operational uptime/downtime) by, for example, processing the FSM state information (e.g., comparing the timestamp where the Idle state begins and the timestamp where the Inactive state begins to obtain the operational downtime, etc.), record the cell health metrics in the local cache and the database, and then update the table (managed by the stats client) with the cell health metrics upon elapsing of the predetermined time period of the timer. Similar operations may occur at 12:03 and 12:04, where the state transitions occur.

In view of the above, example embodiments of the present disclosure provide systems and devices that utilize a local cache (and optionally, a database) to track or record the transitions of the cell FSM state and the associated information (e.g., current state, timestamp, etc.), and then compute the cell health metrics based thereon. Accordingly, the systems and devices of example embodiments require only one timer to trigger the synchronization of the data in the local cache with the table managed by the stats client and transmit the table to the northbound components (e.g., CU that implements the stats server, SMO, etc.), and the granularity of the timer can be reduced (e.g., the granularity can be reduced to one minute as compared to one second as required in the related art, etc.). In this regard, example embodiments of the present disclosure may accurately track and record the FSM state information, especially when there is a change in the cell state between timer callbacks. Consequently, the local, stateful architecture may be updated accordingly at each state transition and on each timer callback, and the cell health metrics may be accurately and comprehensively computed based thereon.

Example embodiments of the present disclosure may also take into consideration the scenarios when the system manager experiences downtime and recovers therefrom. For instance, after the system manager has recovered from the downtime, the system manager may need to determine whether and how to add the associated downtime to the operational uptime/downtime of the cell when calculating the cell health metrics. As further described in the following, example embodiments introduce several parameters to address the aforesaid scenarios.

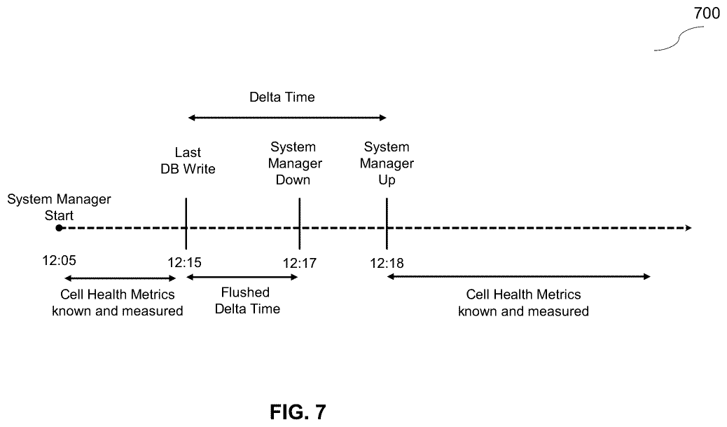

FIG. 7 illustrates a diagram 700 of a second non-limiting use case, according to one or more example embodiments.

As illustrated in FIG. 7, the system manager started at 12:05, went down at 12:17, and went back up at 12:18. In this example use case, the cell health metrics (including the operational uptime/downtime of the cell) up to 12:15 are written to the database. Upon restarting at 12:18, the system manager may retrieve the information associated with the previously determined cell health metrics (e.g., a time at which the previously determined cell health metrics were written to the database, a previously determined operational downtime/uptime, etc.) from the database.

Subsequently, calculations are performed to determine the operational uptime/downtime of the cell associated with the system manager's downtime. For instance, the system manager may calculate a delta time based on a current time and the time at which the previously determined cell health metrics were written to the database, and then add the delta time to the previously determined operational uptime/downtime to thereby obtain the operational uptime/downtime of the cell. The delta time may be calculated based on the following formula (1):

$$delta\_time = curren\_time - db\_write \_time \qquad ( 1 )$$

The parameter “current_time” in formula (1) may refer to the current time (e.g., time when the system manager recovered) as per the internal clock of the system manager. The parameter “db_write_time” in formula (1) may refer to the time at which the cell health metrics are last written to the database. In this case, the “delta time” may refer to the time for which the system manager was down, aggregated with the time at which the cell health metrics are last written to or stored in the database.

In the example use case of FIG. 7, the “db_write_time” is 12:15, and the “current time” is 12:18. Thus, the “delta_time” may refer to the time period between 12:15 and 12:18, i.e., 3 minutes. Accordingly, the delta time may be added to the uptime/downtime as per the last state of the cell FSM. In this regard, although the data till 12:17 was sent to the stats server (as part of every minute transmission), the system manager may overwrite the data between the two minutes from 12:15 to 12:17. Namely, the data previously recorded and associated within 12:15 to 12:17 may be flushed and overwritten since they are part of the delta time.

According to example embodiments where the last state of the cell FSM is an Active state, the delta time may be added to the previously determined operational uptime to obtain the operational uptime of the cell based on the following formula (2):

$$uptime = uptime + delta\_time \qquad ( 2 )$$

According to example embodiments where the last state of the cell FSM is an Inactive/Idle state, the delta time may be added to the previously determined operational downtime to obtain the operational downtime of the cell according to the type of cell unavailability cause set.

For instance, the operational downtime of an Inactive/Idle cell due to a management operation may be calculated based on the following formula (3):

$$downtime\_mgmt = downtime\_mgmt + delta\_time \qquad ( 3 )$$

As another example, the operational downtime of an Inactive/Idle cell due to a software failure may be calculated based on the following formula (4):

$$downtime\_sw = downtime\_sw + delta\_time \qquad ( 4 )$$

As yet another example, the operational downtime of an Inactive/Idle cell due to other factors may be calculated based on the following formula (5):

$$downtime\_other = downtime\_other + delta\_time \qquad ( 5 )$$

Upon calculating the operational uptime/downtime based on the delta time, the data may be stored in the local structures (e.g., local cache, database, etc.). Accordingly, upon elapsing of a predetermined amount of time of the timer (e.g., 1 minute), the local structures may update the table of the stats client and transmit the table to the northbound components (e.g., a component that implements the stats server, an SMO, etc.).

In addition to the above-mentioned embodiments, example embodiments of the present disclosure may also take into consideration the scenarios when the cell health metrics have been transmitted to the stats server and streamed to other northbound components when the system manager goes down, and thus the system manager may need to determine which cell health metrics to be excluded from consideration after recovering from the downtime. As further described in the following, example embodiments introduce several parameters to address the aforesaid scenarios.

Specifically, example embodiments of the present disclosure introduce a reporting period (ROP) which is a timeframe for which the cell health metrics are reported to an entity (e.g., stats server, etc.). The ROP may be predefined by, for example, the network operator. In this regard, if the system manager goes down during a first ROP (e.g., ROP-1) and recovers in a second ROP (e.g., ROP-2), there are multiple components of the delta time that need to be considered, since the system manager (or the stats client implemented therein) transmits data to the stats server (every 1 minute, etc.) and the stats server further streams the data to the northbound components without interacting with the system manager.

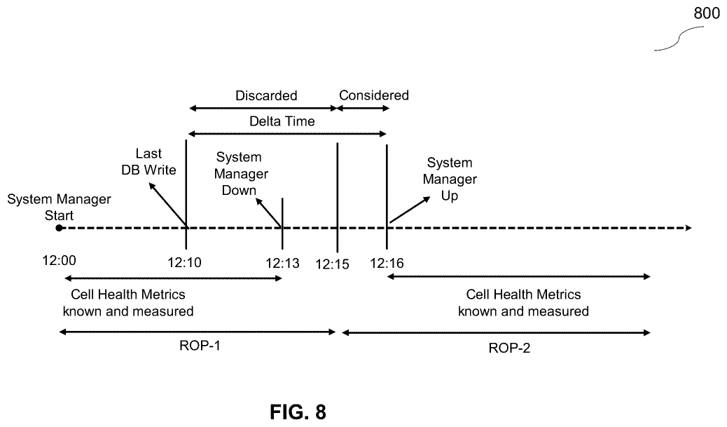

FIG. 8 illustrates a diagram 800 of a third non-limiting use case, according to one or more example embodiments.

As illustrated in FIG. 8, the system manager started at 12:00, went down at 12:13, and went back up at 12:16. The cell health metrics (including uptime/downtime of the cell) up to 12:10 have been written to the database. The cell health metrics up to 12:13 are measured and transmitted to the stats server. The ROP-1 started at 12:00 and ended at 12:15, and the ROP-2 started at 12:15. The data for the timeframe 12:00 to 12:15 got pushed from the stats server to the northbound components (e.g., SMO), prior to the system manager coming up. In this regard, the system manager may not peg the data from 12:13 to 12:15, as the corresponding data was already streamed to the northbound components. In this regard, if the delta time related to ROP-1 is not excluded, it may result in erroneous values for ROP-2.

In this regard, the system manager may utilize or derive several parameters for identifying the ROP boundaries, after which the cell health metrics of the previous ROP may be excluded from consideration.

For instance, the system manager may compare the parameters “db_write_time” (described above in formula (1)) with “rop_start_time” (which represents the start time of the current ROP), to thereby identify if the system manager went down in the previous ROP and came back up in the current ROP. For instance, if the db_write_time is less than the rop_start_time, the system manager may identify that the system manager has gone down in the previous ROP and came back up in the current ROP. Otherwise, if the db_write_time is not less than the rop_start_time, the system manager may identify that the system manager went down and came back up in the same ROP. In this regard, the delta_time to be added to the previously determined operational uptime/downtime of the cell may be calculated based on the following formulas (6) and (7):

$$when db\_write \_time < rop\_start \_time = TRUE \qquad ( 6 )$$

$$delta\_time = current\_time - rop\_start \_time$$

$$when db\_write \_time < rop\_start \_time = FALSE \qquad ( 7 )$$

$$delta\_time = current\_time - db\_write \_time$$

The formula (7) may be similar to formula (1) described hereinabove, but will be applicable only when the db_write_time is not less than the rop_start_time (i.e., when the system manager went down and recovered within the same ROP).

In the example use case of FIG. 8, the data from 12:00 to 12:13 was measured and transmitted to the stats server, and at 12:15 the data from the stats server was relayed to the northbound components. In this case, the db_write_time is 12:10 and the rop_start_time is 12:15 (since the system manager is recovered during ROP-2 at 12:16), i.e., the above-described formula (6) should be applied in determining the delta time. Thus, there is no need to consider the delta time from 12:10 to 12:15, and the considered delta time would be 1 minute (i.e., 12:15 to 12:16).

In view of the above, the calculation of the delta time may be performed based on the state of the cell FSM and the ROP in which the system manager recovered. Accordingly, depending on the cell's last recorded state, the delta time will be aggregated with the corresponding cell statistics metrics stored in the database, whether it pertains to uptime or downtime.

To this end, example embodiments of the present disclosure provide systems and devices that utilize a local cache (and a database, when applicable) to record the cell FSM state and the associated information upon detecting a transition of the cell FSM state, and then calculate or derive the cell health metrics based thereon. Accordingly, the number of timers in the system manager may be reduced to only one timer, and the granularity of the timer may be reduced (e.g., from 1 second to 1 minute), thereby reducing the network resources (e.g., CPU usage, etc.) required for managing the cell health metrics. In addition, example embodiments of the present disclosure also provide mechanisms for determining a delta time and computing the cell health metrics based thereon, thereby achieving a quick and automated recovery of cell health metrics in the event of the system manager downtime.

Ultimately, the systems and devices of the example embodiments effectively and efficiently provide accurate and comprehensive cell health metrics to the northbound components (e.g., CU, SMO), thereby enabling high availability of network services and high stability of network performance since the northbound components may accurately manage the network/services and perform decision-making based on the accurate and comprehensive data.

### Example Operations

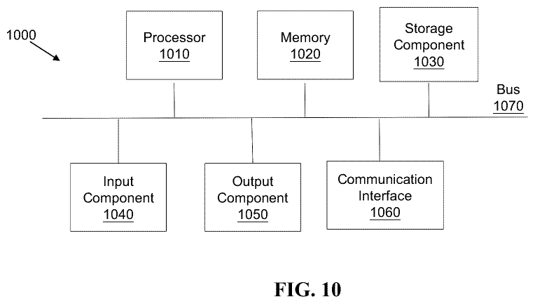

Example operations for managing the cell health metrics, according to one or more example embodiments, are described in the following. One or more operations described herein may be performed by a device (e.g., a server, etc.) that implements one or more components (e.g., system manager, etc.) of the example embodiments. For instance, the operation(s) may be performed by a processor of the device, upon executing computer-readable instructions or computer-executable instructions stored in a storage or memory of the device. Further descriptions of an example device are provided below with reference to FIG. 10.

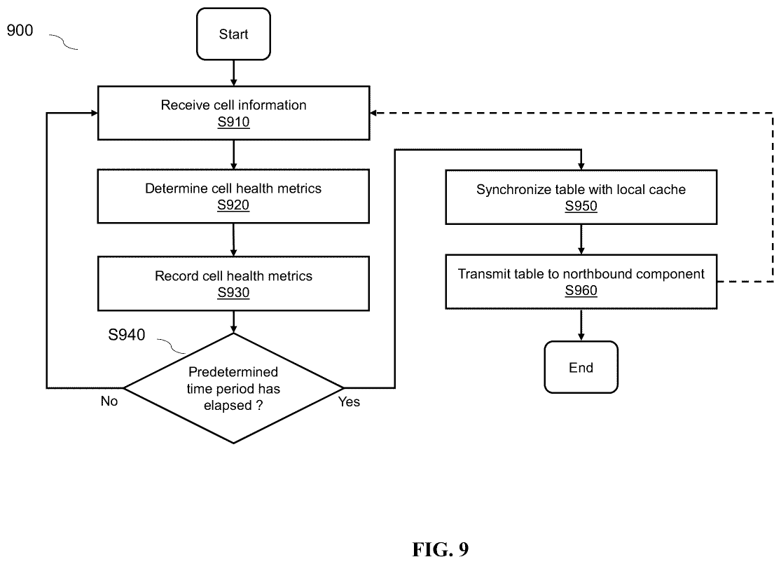

FIG. 9 illustrates a flow diagram of an example method 900 for managing cell health metrics, according to one or more example embodiments. One or more operations of method 900 may involve one or more features/components described above with reference to above Figures. For instance, the operation(s) may be performed by the device that implements the system manager to provide cell health metrics to a northbound component (e.g., a CU that implements the stats server, an SMO, etc.). In addition, one or more operations of method 900 may involve the state transitions of the cell FSM, may involve the formulas (1)-(7), and the like. Thus, redundant descriptions associated therewith may be omitted below for conciseness.

As illustrated in FIG. 9, at operation S910, the device may be configured to receive cell information associated with a cell in a telecommunication network. The cell information may include a current state of a finite state machine (FSM) associated with the cell, while the current state may include at least one of: an Idle state, an Inactive state, and an Active state. According to example embodiments, the device may periodically push the cell configuration from the cell and then extract the cell information therefrom. Alternatively or additionally, the device may push the cell configuration from the cell in real-time (or near-real-time) and then extract the cell information therefrom.

At operation S920, the device may be configured to determine, based on the cell information, cell health metrics associated with the cell. For instance, the device may determine whether the FSM has transitioned from a previous state to the current state (i.e., whether a transition of the state of the cell FSM has occurred). Accordingly, based on determining that the FSM has transitioned from the previous state to the current state (i.e., a transition of the state of the cell FSM has occurred), the device may determine the operational downtime/operational uptime of the cell.

According to example embodiments, the device may determine the operational downtime/operational uptime by comparing a timestamp of the current state with a timestamp of a previous state. For instance, assuming that the current state is an Active state and the previous state is an Idle/Inactive state (i.e., the cell FSM has transitioned from the Idle/Inactive state to the Active state), the device may compare the timestamp at which the Active state started with the timestamp at which the Idle/Inactive state started (e.g., subtract the time at which the Idle/Inactive state started from the time at which the Active state started) to thereby determining the operational downtime (i.e., the time period at which the cell was in the Idle/Inactive state). As another example, assuming that the current state is an Inactive state and the previous state is an Idle state (i.e., the cell FSM has transitioned from the Idle state to the Inactive state), the device may compare the timestamp at which the Inactive state started with the timestamp at which the Idle state started (e.g., subtract the time at which the Idle state started from the time at which the Inactive state started) to thereby determining the operational downtime (i.e., the time period at which the cell was in the Idle state). As yet another example, assuming that the current state is an Idle/Inactive state and the previous state is an Active state (i.e., the cell FSM has transitioned from the Active state to the Idle/Inactive state), the device may compare the timestamp at which the Idle/Inactive state started with the timestamp at which the Active state started (e.g., subtract the time at which the Active state started from the time at which the Idle/Inactive state started) to thereby determining the operational uptime (i.e., the time period at which the cell was in Active state). According to example embodiments, the operational downtime may include at least one of: a downtime due to a management operation, a downtime due to a software failure, and a downtime due to other factors such as at least one of: a midhaul failure, a fronthaul failure, and a timing issue.

According to example embodiments, the device may determine the operational downtime/operational uptime based on a delta time (which may involve one or more of the formulas (1)-(7) described hereinabove).

According to example embodiments, the device may obtain, from a database, information associated with previously determined cell health metrics. The information may include a time at which the previously determined cell health metrics were written to the database (e.g., a “db_write_time”) and a previously determined operational downtime/uptime. Subsequently, the device may determine the delta time based on a current time and the time at which the previously determined cell health metrics were written to the database. Accordingly, the device may add the delta time to the previously determined operational downtime/uptime (e.g., one of the formulas (2)-(5), etc.) to thereby obtain the operational downtime/uptime of the cell.

According to example embodiments, the device may determine the delta time by: determining whether the time at which the determined cell health metrics were written to the database is less than a time when a reporting period started (e.g., whether db_write_time<rop_start_time=TRUE or db_write_time<rop_start_time=FALSE). Accordingly, based on determining that the time at which the determined cell health metrics were written to the database is less than the time when the reporting period started (i.e., db_write_time<rop_start_time=TRUE), the device may determine the delta time by subtracting the time when the reporting period started from the current time (e.g., formula (6)). On the other hand, based on determining that the time at which the determined cell health metrics were written to the database is not less than the time when the reporting period started (i.e., db_write_time<rop_start_time=FALSE), the device may determine the delta time by subtracting the time at which the previous cell health metrics were written to the database from the current time (e.g., formula (7)).

Referring still to FIG. 9, upon determining the cell health metrics, method 900 may proceed to operation S930, at which the device may be configured to record the cell health metrics in a local cache. In some example implementations, the device may further transmit the cell health metrics to a database to store the cell health metrics therein.

At operation S940, the device may be configured to determine whether a predetermined time period has elapsed. The predetermined time period may be associated with a timer of the device that is triggered upon detecting a state transition of the cell FSM. According to example embodiments, the predetermined time period may be at least one minute and may be predetermined by a user of the telecommunication network (e.g., a network operator, etc.).

Based on determining that the predetermined time period has not yet elapsed, method 900 may return to operation S910, such that the device may be configured to repeat operations S910-S940 until the predetermined time period has elapsed. This enables the subsequent cell health metrics (if any) to be computed and accumulated in the local cache when multiple state transitions of the cell FSM occur within the predetermined time period. In some example embodiments, the device may be configured to overwrite the local cache with specific cell health metrics (e.g., cell health metrics computed based on the information of the latest state transition, etc.) until the predetermined time period has elapsed.

Based on determining that the predetermined time period has elapsed, method 900 may proceed to operation S950, at which the device may be configured to synchronize a table with the cell health metrics recorded in the local cache. According to example embodiments, the table may be managed by a stats client of the device. In this case, the device may obtain the table from a local storage (e.g., a memory or storage of the device) and then update the table with the cell health metrics recorded in the local cache (e.g., adding the cell health metrics into the table, overwriting an existing record with the cell health metrics, etc.). In some example implementations, the device may store a copy of the table in the database. In this case, the device may obtain the table from the database, update the table with the cell health metrics recorded in the local cache, and then transmit the updated table to the database.

At operation S960, the device may be configured to transmit the table to a northbound component. The northbound component may include at least one of: a CU (that may implement the stats server), an SMO, and the like. Upon performing operation S960, method 900 may be ended. Alternatively, method 900 may return to operation S910, such that the device may be configured to repeat operations S910-S960 for at least a predetermined period of time.

It is contemplated that operations S950 and S960 may be performed in any suitable sequence. For instance, the device may perform operation S950 (to synchronize the table with the local cache) and then perform operation S960 (to transmit the synchronized table to the northbound component), may perform operation S960 (to transmit a previously synchronized table to the northbound component) and then perform operation S950 (to further synchronize the table with the local cache), may concurrently perform operations S950 and S960, and the like.

In view of the above, example embodiments of the present disclosure provide methods and operations for recording cell FSM state and the associated information in a local cache (and a database, when applicable) upon detecting a transition of the cell FSM state and for determining the cell health metrics based thereon. Accordingly, the methods and operations of the example embodiments only require one timer with a reduced granularity, thereby reducing the network resources (e.g., CPU usage, etc.) required for managing the cell health metrics. In addition, the example embodiments also provide methods and operations for determining a delta time and computing the cell health metrics based thereon, thereby achieving a quick and automated recovery of cell health metrics in the event of the system manager downtime.

Ultimately, the methods and operations of the example embodiments effectively and efficiently provide accurate and comprehensive cell health metrics to the northbound components (e.g., CU, SMO), thereby enabling high availability of network services and high stability of network performance since the northbound components may accurately manage the network/services and perform decision-making based on the accurate and comprehensive data.

### Example Device

One or more components of the example embodiments (e.g., system manager, etc.), as well as the operations associated therewith, may be implemented in one or more devices or hardware components. For instance, one or more components/operations of the system manager may be implemented in one or more devices like a server(s), and the like.

In the following, descriptions of a device in which the example embodiments may be implemented are provided. It is contemplated that one or more features, operations, and methods described above may be performed by the device. For instance, the one or more operations or methods may be performed by at least one processor of the device upon executing machine-readable instructions or computer-readable instructions stored in a memory or a storage component of the device.

FIG. 10 illustrates an embodiment of a device 1000. As shown in FIG. 10, the device 1000 may include a processor 1010, a memory 1020, a storage component 1030, an input component 1040, an output component 1050, a communication interface 1060, and a bus 1070.

The processor 1010, as used herein, means any type of computational circuit that may comprise hardware elements and software elements. The processor 1010 may be embodied as a multi-core processor, a single core processor, or a combination of one or more multi-core processors and/or one or more single core processors, a distributed processing system, or the like. The processor 1010 may be a Central Processing Unit (CPU), a graphics processing unit (GPU), an accelerated processing unit (APU), an application-specific integrated circuit (ASIC), or another type of processing component.

Memory 1020 includes a non-transitory computer readable medium. Memory 1020 includes a random-access memory (RAM), a read only memory (ROM), and/or another type of dynamic or static storage device (e.g., a flash memory, a magnetic memory, and/or an optical memory) that stores information and/or instructions for use by processor 1010. The memory 1020 comprises machine-readable instructions which are executable by the processor 1010. These machine-readable instructions when executed by the processor 1010 cause the processor 1010 to perform one or more method steps of an embodiment described above.

Storage component 1030 stores information and/or software related to the operation and use of the device 1000. For example, storage component 1030 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1040 is configured to receive information, such as user input. For example, the input component 1040 may include, but not be limited to, a touch screen display, a keyboard, a keypad, a mouse, a button, a switch, and/or a microphone. Additionally, or alternatively, the input component 1040 may include a sensor for sensing information (e.g., a global positioning system (GPS), an accelerometer, a gyroscope, and/or an actuator).

Output component 1050 is configured to provide output information from the device 1000. For example, the output component 1050 may be, but not limited to, a display, a speaker, instructions to an external device, and/or one or more light-emitting diodes (LEDs).

Communication interface 1060 is an interface that provides a communication connection to other devices, such as external devices and internal devices. The connection by the communication interface 1060 can be a wired connection, a wireless connection, or a combination of wired and wireless connections, and can be a direct connection or an indirect connection via a communication network that exists between the device 1000 and other devices. In other words, the standard of the communication interface 1060 is not limited.

The bus 1070 acts as an interconnect between the processor 1010, the memory 1020, the storage component 1030, the input component 1040, the output component 1050, and the communication interface 1060 of the device 1000. The bus 1070 may include a wired interconnection or a wireless interconnection.

The number and arrangement of components shown in FIG. 10 are provided as an example. In practice, device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000. Further, one or more method steps described in any of the embodiments may be performed utilizing a plurality of devices 1000 in communication with one another.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the components/operations described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various example embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A device configured to: receive cell information associated with a cell in a telecommunication network, wherein the cell information may include a current state of a finite state machine (FSM) associated with the cell, and wherein the current state may include at least one of: an Idle state, an Inactive state, and an Active state; determine, based on the cell information, cell health metrics associated with the cell; record the cell health metrics in a local cache; determine whether a predetermined time period has elapsed; based on determining that the predetermined time period has elapsed, synchronize a table with the cell health metrics recorded in the local cache; and transmit the table to a northbound component of the telecommunication network.

Item [2]: The device according to item [1], wherein the predetermined time period is at least one minute.

Item [3]: The device according to any one of items [1]-[2], wherein the device may be configured to determine the cell health metrics by: determining whether the FSM has transitioned from a previous state to the current state; based on determining that the FSM has transitioned from the previous state to the current state, determine at least one of: an operational downtime of the cell and an operational uptime of the cell; and recording the current state of the FSM and the at least one of the operational downtime and the operational uptime in the local cache.

Item [4]: The device according to item [3], wherein the device may be configured to determine the at least one of the operational downtime and the operational uptime of the cell by: obtaining, from a database, information associated with previously determined cell health metrics, wherein the information may include: a time at which the previously determined cell health metrics were written to the database and at least one of a previously determined operational downtime and a previously determined operational uptime; determining, based on a current time and the time at which the previously determined cell health metrics were written to the database, a delta time; and adding the delta time to the at least one of the previously determined operational downtime and the previously determined operational uptime to obtain the at least one of the operational downtime and the operational uptime.

Item [5]: The device according to item [4], wherein the device is configured to determine the delta time by: determining whether the time at which the previously determined cell health metrics were written to the database is less than a time when a reporting period started; based on determining that the time at which the previous cell health metrics were written to the database is less than the time when the reporting period started, determining the delta time by subtracting the time when the reporting period started from the current time; and based on determining that the time at which the previously determined cell health metrics were written to the database is not less than the time when the reporting period started, determining the delta time by subtracting the time at which the previous cell health metrics were written to the database from the current time.

Item [6]: The device according to any one of items [3]-[5], wherein the operational downtime of the cell may include at least one of: a downtime due to a management operation; a downtime due to a software failure; and a downtime due to at least one of: a midhaul failure, a fronthaul failure, and a timing issue.

Item [7]: The device according to any one of items [1]-[6], wherein the northbound component may include at least one of: a central unit (CU) and a service management and orchestration (SMO) framework.

Item [8]: The device according to any one of items [1]-[7], wherein the device may be further configured to: upon determining the cell health metrics, transmit the cell health metrics to a database.

Item [9]: A method including: receiving cell information associated with a cell in a telecommunication network, wherein the cell information may include a current state of a finite state machine (FSM) associated with the cell, and wherein the current state may include at least one of: an Idle state, an Inactive state, and an Active state; determining, based on the cell information, cell health metrics associated with the cell; recording the cell health metrics in a local cache; determining whether a predetermined time period has elapsed; based on determining that the predetermined time period has elapsed, synchronizing a table with the cell health metrics recorded in the local cache; and transmitting the table to a northbound component of the telecommunication network.

Item [10]: The method according to item [9], wherein the predetermined time period is at least one minute.

Item [11]: The method according to any one of items [9]-[10], wherein the determining the cell health metrics may include: determining whether the FSM has transitioned from a previous state to the current state; based on determining that the FSM has transitioned from the previous state to the current state, determining at least one of: an operational downtime of the cell and an operational uptime of the cell; and recording the current state of the FSM and the at least one of the operational downtime and the operational uptime in the local cache.

Item [12]: The method according to item [11], wherein the determining the at least one of the operational downtime and the operational uptime of the cell may include: obtaining, from a database, information associated with previously determined cell health metrics, wherein the information may include: a time at which the previously determined cell health metrics were written to the database and at least one of a previously determined operational downtime and a previously determined operational uptime; determining, based on a current time and the time at which the previously determined cell health metrics were written to the database, a delta time; and adding the delta time to the at least one of the previously determined operational downtime and the previously determined operational uptime to obtain the at least one of the operational downtime and the operational uptime.

Item [13]: The method according to item [12], wherein the determining the delta time may include: determining whether the time at which the previously determined cell health metrics were written to the database is less than a time when a reporting period started; based on determining that the time at which the previous cell health metrics were written to the database is less than the time when the reporting period started, determining the delta time by subtracting the time when the reporting period started from the current time; and based on determining that the time at which the previously determined cell health metrics were written to the database is not less than the time when the reporting period started, determining the delta time by subtracting the time at which the previous cell health metrics were written to the database from the current time.

Item [14]: The method according to any one of items [11]-[13], wherein the operational downtime of the cell may include at least one of: a downtime due to a management operation; a downtime due to a software failure; and a downtime due to at least one of: a midhaul failure, a fronthaul failure, and a timing issue.

Item [15]: The method according to any one of items [9]-[14], wherein the northbound component may include at least one of: a central unit (CU) and a service management and orchestration (SMO) framework.

Item [16]: The method according to any one of items [9]-[15], further including: upon determining the cell health metrics, transmitting the cell health metrics to a database.

Item [17]: A non-transitory computer-readable recording medium having recorded thereon instructions executable by a device to cause the device to perform a method including: receiving cell information associated with a cell in a telecommunication network, wherein the cell information may include a current state of a finite state machine (FSM) associated with the cell, and wherein the current state may include at least one of: an Idle state, an Inactive state, and an Active state; determining, based on the cell information, cell health metrics associated with the cell; recording the cell health metrics in a local cache; determining whether a predetermined time period has elapsed; based on determining that the predetermined time period has elapsed, synchronizing a table with the cell health metrics recorded in the local cache; and transmitting the table to a northbound component of the telecommunication network.

Item [18]: The non-transitory computer-readable recording medium according to item [17], wherein the predetermined time period is at least one minute.

Item [19]: The non-transitory computer-readable recording medium according to any one of items [17]-[18], wherein the determining the cell health metrics may include: determining whether the FSM has transitioned from a previous state to the current state; based on determining that the FSM has transitioned from the previous state to the current state, determining at least one of: an operational downtime of the cell and an operational uptime of the cell; and recording the current state of the FSM and the at least one of the operational downtime and the operational uptime in the local cache.

Item [20]: The non-transitory computer-readable recording medium according to item [19], wherein the determining the at least one of the operational downtime and the operational uptime of the cell may include: obtaining, from a database, information associated with previously determined cell health metrics, wherein the information comprises: a time at which the previously determined cell health metrics were written to the database and at least one of a previously determined operational downtime and a previously determined operational uptime; determining, based on a current time and the time at which the previously determined cell health metrics were written to the database, a delta time; and adding the delta time to the at least one of the previously determined operational downtime and the previously determined operational uptime to obtain the at least one of the operational downtime and the operational uptime.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A device configured to:
receive cell information associated with a cell in a telecommunication network, wherein the cell information comprises a current state of a finite state machine (FSM) associated with the cell, and wherein the current state comprises at least one of: an Idle state, an Inactive state, and an Active state;
determine, based on the cell information, cell health metrics associated with the cell;
record the cell health metrics in a local cache;
determine whether a predetermined time period has elapsed;
based on determining that the predetermined time period has elapsed, synchronize a table with the cell health metrics recorded in the local cache; and
transmit the table to a northbound component of the telecommunication network.

2. The device according to claim 1, wherein the predetermined time period is at least one minute.

3. The device according to claim 1, wherein the device is configured to determine the cell health metrics by:
determining whether the FSM has transitioned from a previous state to the current state;
based on determining that the FSM has transitioned from the previous state to the current state, determining at least one of: an operational downtime of the cell and an operational uptime of the cell; and
recording the current state of the FSM and the at least one of the operational downtime and the operational uptime in the local cache.

4. The device according to claim 3, wherein the device is configured to determine the at least one of the operational downtime and the operational uptime of the cell by:
obtaining, from a database, information associated with previously determined cell health metrics, wherein the information comprises: a time at which the previously determined cell health metrics were written to the database and at least one of a previously determined operational downtime and a previously determined operational uptime;
determining, based on a current time and the time at which the previously determined cell health metrics were written to the database, a delta time; and
adding the delta time to the at least one of the previously determined operational downtime and the previously determined operational uptime to obtain the at least one of the operational downtime and the operational uptime.

5. The device according to claim 4, wherein the device is configured to determine the delta time by:
determining whether the time at which the previously determined cell health metrics were written to the database is less than a time when a reporting period started;
based on determining that the time at which the previous cell health metrics were written to the database is less than the time when the reporting period started, determining the delta time by subtracting the time when the reporting period started from the current time; and
based on determining that the time at which the previously determined cell health metrics were written to the database is not less than the time when the reporting period started, determining the delta time by subtracting the time at which the previous cell health metrics were written to the database from the current time.

6. The device according to claim 3, wherein the operational downtime of the cell comprises at least one of:
a downtime due to a management operation;
a downtime due to a software failure; and
a downtime due to at least one of: a midhaul failure, a fronthaul failure, and a timing issue.

7. The device according to claim 1, wherein the northbound component comprises at least one of: a central unit (CU) and a service management and orchestration (SMO) framework.

8. The device according to claim 1, wherein the device is further configured to:
upon determining the cell health metrics, transmit the cell health metrics to a database.

9. A method comprising:
receiving cell information associated with a cell in a telecommunication network, wherein the cell information comprises a current state of a finite state machine (FSM) associated with the cell, and wherein the current state comprises at least one of: an Idle state, an Inactive state, and an Active state;
determining, based on the cell information, cell health metrics associated with the cell;
recording the cell health metrics in a local cache;
determining whether a predetermined time period has elapsed;
based on determining that the predetermined time period has elapsed, synchronizing a table with the cell health metrics recorded in the local cache; and
transmitting the table to a northbound component of the telecommunication network.

10. The method according to claim 9, wherein the predetermined time period is at least one minute.

11. The method according to claim 9, wherein the determining the cell health metrics comprises:
determining whether the FSM has transitioned from a previous state to the current state;
based on determining that the FSM has transitioned from the previous state to the current state, determining at least one of: an operational downtime of the cell and an operational uptime of the cell; and
recording the current state of the FSM and the at least one of the operational downtime and the operational uptime in the local cache.

12. The method according to claim 11, wherein the determining the at least one of the operational downtime and the operational uptime of the cell comprises:
obtaining, from a database, information associated with previously determined cell health metrics, wherein the information comprises: a time at which the previously determined cell health metrics were written to the database and at least one of a previously determined operational downtime and a previously determined operational uptime;
determining, based on a current time and the time at which the previously determined cell health metrics were written to the database, a delta time; and
adding the delta time to the at least one of the previously determined operational downtime and the previously determined operational uptime to obtain the at least one of the operational downtime and the operational uptime.

13. The method according to claim 12, wherein the determining the delta time comprises:
determining whether the time at which the previously determined cell health metrics were written to the database is less than a time when a reporting period started;
based on determining that the time at which the previous cell health metrics were written to the database is less than the time when the reporting period started, determining the delta time by subtracting the time when the reporting period started from the current time; and
based on determining that the time at which the previously determined cell health metrics were written to the database is not less than the time when the reporting period started, determining the delta time by subtracting the time at which the previous cell health metrics were written to the database from the current time.

14. The method according to claim 11, wherein the operational downtime of the cell comprises at least one of:
a downtime due to a management operation;
a downtime due to a software failure; and
a downtime due to at least one of: a midhaul failure, a fronthaul failure, and a timing issue.

15. The method according to claim 9, wherein the northbound component comprises at least one of: a central unit (CU) and a service management and orchestration (SMO) framework.

16. The method according to claim 9, further comprising:
upon determining the cell health metrics, transmitting the cell health metrics to a database.

17. A non-transitory computer-readable recording medium having recorded thereon instructions executable by a device to cause the device to perform a method comprising:
receiving cell information associated with a cell in a telecommunication network, wherein the cell information comprises a current state of a finite state machine (FSM) associated with the cell, and wherein the current state comprises at least one of: an Idle state, an Inactive state, and an Active state;
determining, based on the cell information, cell health metrics associated with the cell;
recording the cell health metrics in a local cache;
determining whether a predetermined time period has elapsed;
based on determining that the predetermined time period has elapsed, synchronizing a table with the cell health metrics recorded in the local cache; and
transmitting the table to a northbound component of the telecommunication network.

18. The non-transitory computer-readable recording medium according to claim 17, wherein the predetermined time period is at least one minute.

19. The non-transitory computer-readable recording medium according to claim 17, wherein the determining the cell health metrics comprises:
determining whether the FSM has transitioned from a previous state to the current state;
based on determining that the FSM has transitioned from the previous state to the current state, determining at least one of: an operational downtime of the cell and an operational uptime of the cell; and
recording the current state of the FSM and the at least one of the operational downtime and the operational uptime in the local cache.

20. The non-transitory computer-readable recording medium according to claim 19, wherein the determining the at least one of the operational downtime and the operational uptime of the cell comprises:
obtaining, from a database, information associated with previously determined cell health metrics, wherein the information comprises: a time at which the previously determined cell health metrics were written to the database and at least one of a previously determined operational downtime and a previously determined operational uptime;
determining, based on a current time and the time at which the previously determined cell health metrics were written to the database, a delta time; and
adding the delta time to the at least one of the previously determined operational downtime and the previously determined operational uptime to obtain the at least one of the operational downtime and the operational uptime.
